(19) United States
(12) Patent Application Publication
(10) Pub. No.: US 2008/0194393 A1
(43) Pub. Date: Aug. 14, 2008

(54) Method and Apparatus for Folding an Air Bag for Stowing in an Air Bag Module

(75) Inventors: Curtis Clarke, Grand Blanc, MI (US); Axel Castellanos, Coahuala (MX); James Garvin, San Antonio, TX (US); Steven Moon, Schwartz Creek, MI (US); Paul Walsh, Waterford, MI (US); Humberto Hernandez, Coahuala (MX); Andres Rojero, Coahuala (MX)

Correspondence Address: FOLEY AND LARDNER LLP;SUITE 500, 3000 K STREET NW, WASHINGTON, DC, 20007, US

(73) Assignee: Takata Restraint Systems, Inc., Auburn Hills, MI (US)

(21) Appl. No.: 10/598,252

(22) PCT Filed: Feb. 23, 2005
(86) PCT No.: PCT/US2005/005915

§ 371 Date: Jan. 7, 2008

Related U.S. Application Data
(60) Provisional application No. 60/546,876, filed on Feb. 23, 2004.

(51) Int. Cl. B31B 1/26

(52) U.S. Cl. 493/458; 280/743.1

(57) ABSTRACT

An air bag on a surface is gathered by opposing faces of first and second gathering elements that are moved together from opposing edges of the air bag, and which are adapted so as to limit a height of at least one associated edge portion of the air bag to be less than a height proximate to a center of the resulting gathered air bag. In one aspect, a surface is extended from at least one face, or at least one face is shaped so as to limit the edge portion height upon gathering. In another aspect, at least one gathering element incorporates a holder adapted to hold an edge of the air bag during gathering.

### BRIEF DESCRIPTION OF THE DRAWINGS

In the accompanying drawings:

FIG. 1 illustrates a plan view of a first embodiment of a first aspect of an apparatus for folding an airbag for stowing in an air bag module, with the apparatus positioned at the beginning of the folding operation;

FIG. 2 illustrates a cross-sectional view of the apparatus illustrated in FIG. 1;

FIG. 3 illustrates the apparatus of FIG. 1 positioned at the end of a first gathering operation;

FIG. 4 illustrates a cross-sectional view of the apparatus illustrated in FIG. 3, prior to a second gathering operation;

FIG. 5 illustrates an expanded view of a portion of the cross-sectional view illustrated in FIG. 4;

FIG. 6 illustrates a cross-sectional view of the apparatus illustrated in FIG. 3, after a second gathering operation;

FIG. 7 illustrates a cross-sectional view of a portion of a second embodiment of the first aspect of an apparatus for folding an airbag for stowing in an air bag module;

FIG. 8a illustrates a cross-sectional view of a portion of a third embodiment of the first aspect of an apparatus for folding an airbag for stowing in an air bag module;

FIG. 8b illustrates a cross-sectional view of a portion of a fourth embodiment of the first aspect of an apparatus for folding an airbag for stowing in an air bag module;

FIG. 9 illustrates a cross-sectional view of a portion of a fifth embodiment of the first aspect of an apparatus for folding an airbag for stowing in an air bag module;

FIG. 10 illustrates a cross-sectional view of a portion of a sixth embodiment of the first aspect of an apparatus for folding an airbag for stowing in an air bag module;

FIG. 11 illustrates a cross-sectional view of a portion of a seventh embodiment of the first aspect of an apparatus for folding an airbag for stowing in an air bag module;

FIG. 12 illustrates a cross-sectional view of a portion of a first embodiment of a second aspect of an apparatus for folding an airbag for stowing in an air bag module;

FIG. 13 illustrates a cross-sectional view of a portion of a second embodiment of the second aspect of an apparatus for folding an airbag for stowing in an air bag module;

FIG. 14 illustrates a cross-sectional view of a portion of a third embodiment of the second aspect of an apparatus for folding an airbag for stowing in an air bag module;

FIG. 15 illustrates a first cross-sectional view of a portion of a third aspect of an apparatus for folding an airbag for stowing in an air bag module;

FIG. 16 illustrates a second cross-sectional view of a portion of the third aspect of an apparatus for folding an airbag for stowing in an air bag module; and

FIG. 17 illustrates a third cross-sectional view of a portion of the third aspect of an apparatus for folding an airbag for stowing in an air bag module.

### DESCRIPTION OF EMBODIMENT(S)

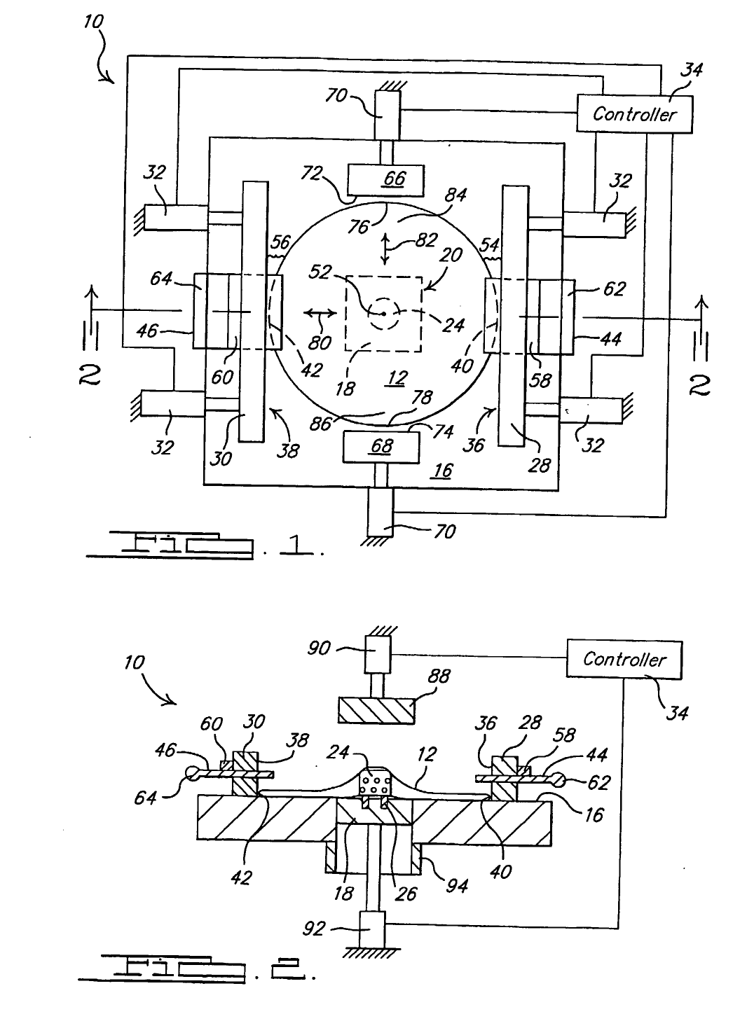

Referring to FIGS. 1-6, in an air bag folding apparatus 10 for folding an air bag 12 for stowing in an air bag module 14, and an associated air bag gathering method, the air bag 12 is spread out over a first surface 16 and a moveable platform 18 below a region 20 to be occupied by the gathered air bag 22 after the associated air bag gathering method is completed, wherein the top of the moveable platform 18 is initially aligned with the first surface 16. A gas generator 24 is inserted in the air bag 12 prior to gathering, and the moveable platform 18 is adapted to receive associated mounting lugs 26 or other projections from the gas generator 24. A first pair of opposed first 28 and second 30 gathering elements located over the first surface 16 are adapted to slidably move with respect to the first surface 16 and with respect to each other, for example, responsive to associated positioners 32 which are responsive to associated signals from an associated controller 34. Although a plurality of associated positioners 32 are illustrated in association with each first 28 and second 30 gathering element, it should be understood that a single positioner 32 could be used for each first 28 and second 30 gathering element or for both first 28 and second 30 gathering elements, or some other number of positioners 32 could be used. Alternatively, the first 28 and second 30 gathering elements could be moved manually. The first 28 and second 30 gathering elements comprise respective first 36 and second 38 faces which are adapted to engage associated first 40 and second 42 edges of the air bag 12.

In accordance with the a first embodiment of a first aspect of the air bag folding apparatus 10, the first 28 and second 30 gathering elements each incorporate associated first 44 and second 46 sliders that are adapted to slide in corresponding first 48 and second 50 slots in the first 28 and second 30 gathering elements, wherein the first 44 and second 46 sliders are located above the associated first 40 and second 42 edges of the air bag 12. The first 44 and second 46 sliders are adapted to slide through the associated first 48 and second 50 slots and to extend inwards from the associated first 36 and second 38 faces towards a center 52 of the air bag folding apparatus 10 in the region 20 where the gas generator 24 is located. The bottom surfaces of the first 44 and second 46 sliders extended from the first 36 and second 38 faces of the first 28 and second 30 gathering elements accordingly provide for limiting the height of associated first 54 and second 56 edge portions of the air bag 12 during the associated folding process. The first 44 and second 46 sliders are provided with associated first 58 and second 60 stops which limits the inward travel of the first 44 and second 46 sliders relative to the first 36 and second 38 faces, so as to provide for controlling the extent of the first 54 and second 56 edge portions for which the height of the gathered air bag 22 is limited. The first 44 and second 46 sliders may also be provided with associated first 62 and second 64 handles so as to provide for the manual operation thereof.

A second pair of opposed third 66 and fourth 68 gathering elements also located over the first surface 16 are also adapted to slidably move with respect to the first surface 16 and with respect to each other, for example, responsive to associated positioners 70 which are responsive to associated signals from the associated controller 34. Although a single associated positioners 32 is illustrated for each of the third 66 and fourth 68 gathering elements, it should be understood that a single positioner 32 could be used for both third 66 and fourth 68 gathering elements, or some other number of positioners 32 could be used. Alternatively, the third 66 and fourth 68 gathering elements could be moved manually. The first 28 and second 30 gathering elements comprise respective third 72 and fourth 74 faces which are adapted to engage associated third 76 and fourth 78 edges of the air bag 12. The first 28 and second 30 gathering elements are operative in a first direction 80, and the third 66 and fourth 68 gathering elements are operative in a second direction 82, wherein, for example, the first 80 and second 82 directions are substantially orthogonal with respect to one another.

Referring to FIGS. 3-5, in accordance with a first gathering operation, the first 28 and second 30 gathering elements are each moved inwards towards each other and towards the center 52, so as to gather the air bag 12 along the first direction 80, wherein the first 54 and second 56 edge portions of the air bag 12 are successively bunched together, followed by a gathering of an associated interior portion 84 of air bag along the first direction 80. The heights of the lower surfaces of the first 44 and second 46 sliders on the associated first 28 and second 30 gathering elements are sufficiently lower than the height of the gathered air bag 22 near the center 52 so as to prevent the associated first 40 and second 42 edges from becoming captured within the folds of the gathered air bag 22. Similarly, the third 66 and fourth 68 gathering elements are each moved inwards towards each other and towards the center 52, so as to gather the air bag 12 along the second direction 82, wherein associated third 84 and fourth 86 edge portions of the air bag 12 proximate to the third 66 and fourth 68 gathering elements are successively bunched together, followed by a gathering of the associated interior portion 84 of air bag along the second direction 82. It should be understood that the third 66 and fourth 68 gathering elements may also incorporate associated sliders similar to the first 44 and second 46 sliders incorporated in the first 28 and second 30 gathering elements, similarly adapted so as to limit the height of the associated third 84 and fourth 86 edge portions in the gathered air bag 22.

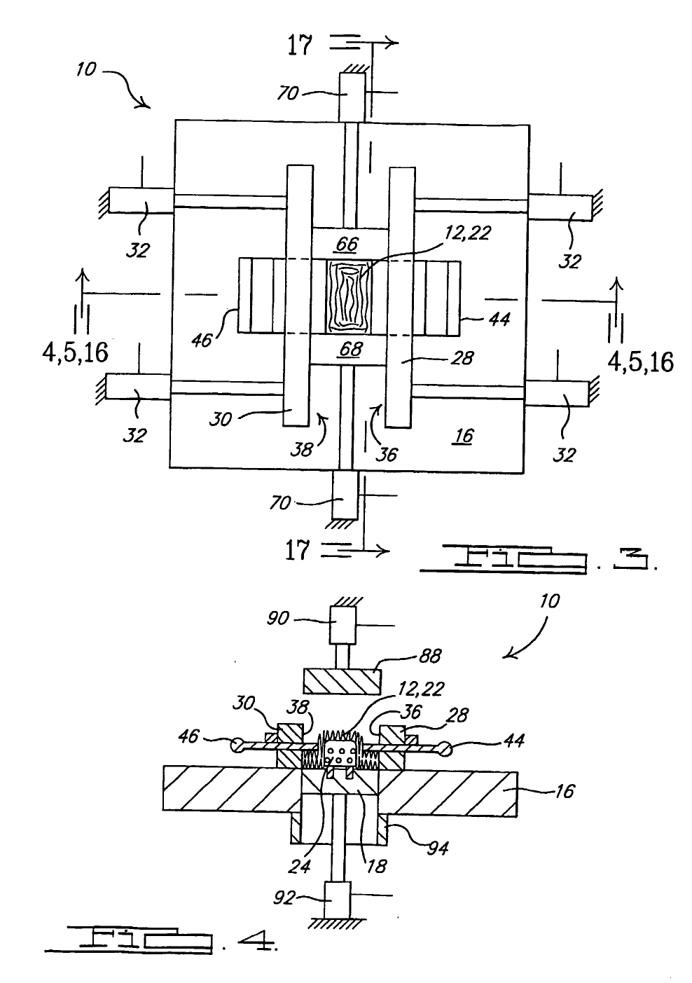

Referring to FIGS. 4 and 6, after the first gathering operation has been completed, thereby gathering an compressing the periphery of the air bag 12 within the region 20 sufficient for stowing within the associated air bag module 14, in accordance with a second gathering operation, the first 44 and second 46 sliders are withdrawn to at least the first 36 and second 38 faces of the first 28 and second 30 gathering elements so as to provide clearance for a pusher plate 88 actuated by an associated positioner 90, or other actuator, responsive to a signal from the controller 34, which vertically compresses the gathered air bag 22, and which in synchronism a lowering of the moveable platform 18 by an associated positioner 92 responsive to an associated signal from the controller 34, provides for transferring the gathered air bag 22 to a sleeve 94 for subsequent transfer to and stowing in the air bag module 14.

Referring to FIG. 7, in accordance with a second embodiment of the first aspect of an apparatus for folding an airbag for stowing in an air bag module, the associated first 44 and second 46 sliders, or other sliders if utilized, may be operatively coupled, for example, via a cable 96, to an associated positioner 98 operative relative to a ground, and controlled responsive to a signal from the controller 34, so as to provide for controlling the position thereof, for example, responsive to the position of the first 28 and second 30 gathering elements, or other associated gathering elements.

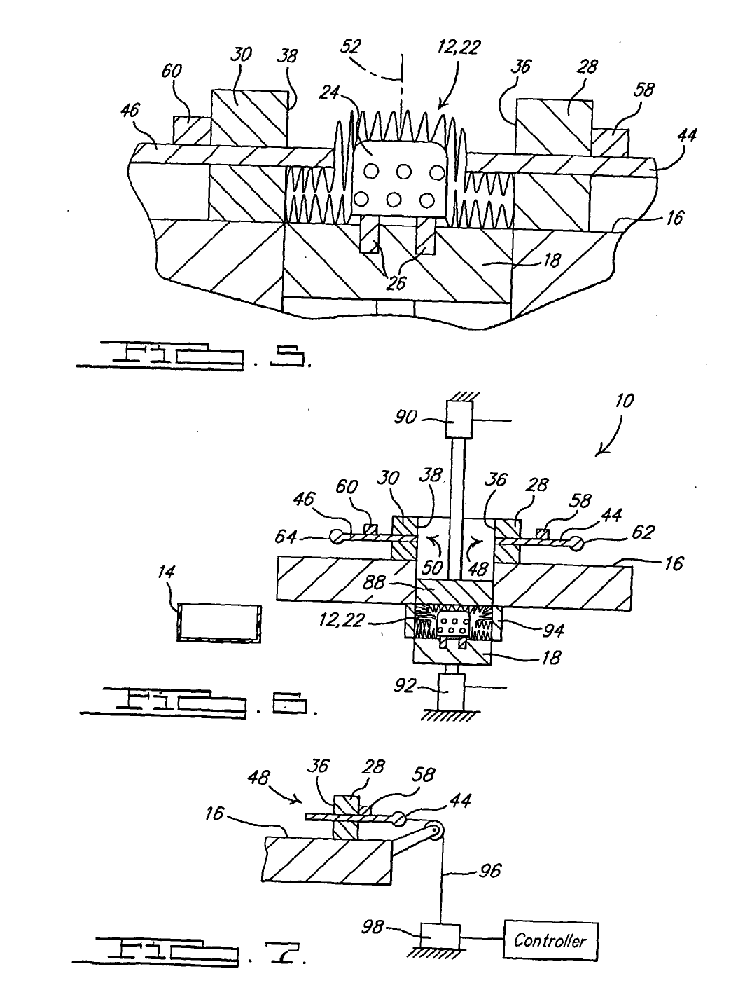

Referring to FIG. 8a, in accordance with a third embodiment of the first aspect of an apparatus for folding an airbag for stowing in an air bag module, the associated first 44 and second 46 sliders, or other sliders if utilized, may be operatively coupled, for example, via a cable 100 coupled to a ground, wherein the length of the cable 100 is adapted to automatically retract the associated first 44 and second 46 sliders, or other sliders if utilized, near the end of the first gathering operation, so as to automatically prepare for the second gathering operation.

Referring to FIG. 8b, in accordance with a fourth embodiment of the first aspect of an apparatus for folding an airbag for stowing in an air bag module, the associated first 44 and second 46 sliders, or other sliders if utilized, may be operatively coupled, for example, via a cable 100 coupled to a weight 102, wherein the length of the cable 100 is adapted to automatically retract the associated first 44 and second 46 sliders, or other sliders if utilized, near the end of the first gathering operation, so as to automatically prepare for the second gathering operation, wherein the size of the weight 102 is sufficient to provide for overcoming friction during retraction of the associated first 44 and second 46 sliders, or other sliders if utilized.

Referring to FIG. 9, in accordance with a fifth embodiment of the first aspect of an apparatus for folding an airbag for stowing in an air bag module, the associated first 44 and second 46 sliders, or other sliders if utilized, may be operatively coupled to an associated positioner 104 operative relative to an associated first 28 or second 30 gathering element, or other gathering element, and controlled responsive to a signal from the controller 34, so as to provide for controlling the position thereof, for example, responsive to the position of the first 28 and second 30 gathering elements, or other associated gathering elements.

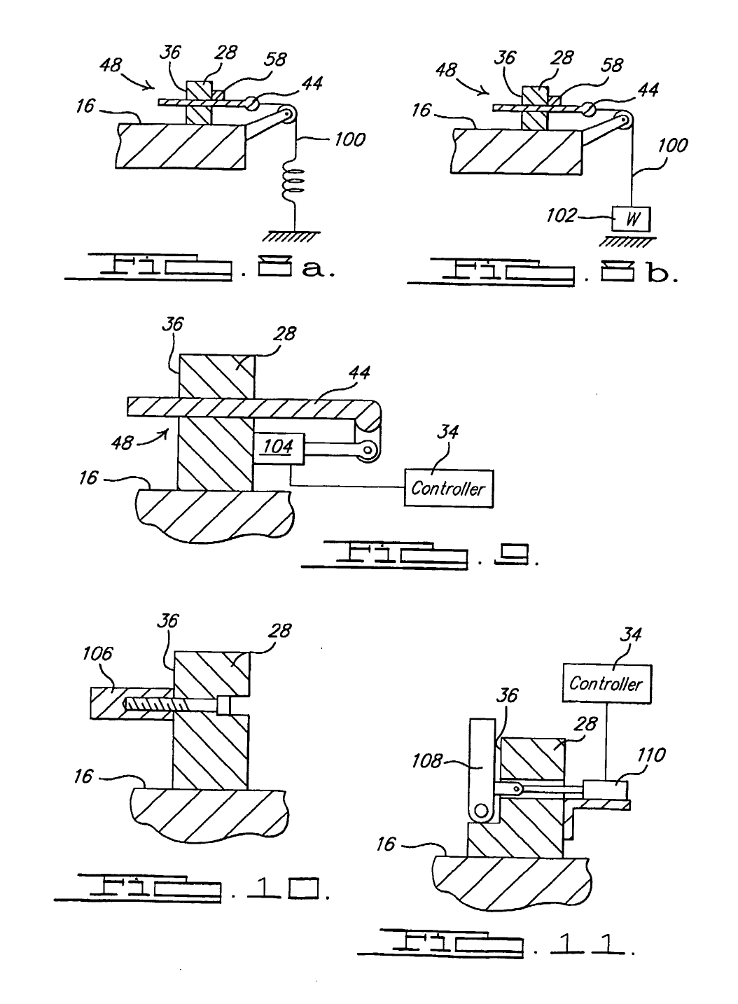

Referring to FIG. 10, in accordance with a sixth embodiment of the first aspect of an apparatus for folding an airbag for stowing in an air bag module, the first 28 or second 30 gathering element, or other gathering element, may be adapted with a fixed guide surface 106, the height of which is adapted similar to that of the first 44 and second 46 sliders described hereinabove, the operation of which during the first gathering operation is also similar.

Referring to FIG. 11, in accordance with a seventh embodiment of the first aspect of an apparatus for folding an airbag for stowing in an air bag module, a flapper 108 is pivoted from the inside of a first 28 or second 30 gathering element, or other gathering element, responsive to an associated positioner 110 controlled by a signal from the controller 34, wherein the flapper 108 is rotated downwards so as to provide for limiting the height of the associated first 54 or second 56 edge portions, or other edge portions, during the first gathering operation, wherein the height of the flapper 108 when deployed is similar to that of the first 44 and second 46 sliders described hereinabove, the operation of which during the first gathering operation is also similar.

Referring to FIG. 12, in accordance with a first embodiment of a second aspect of an apparatus for folding an airbag for stowing in an air bag module, the lower inside portion of the first 36 or second 38 faces of the first 28 or second 30 gathering elements, or other associated faces of other associated gathering elements, is provided with a clamp 112, for example, a spring clamp, which provides for holding the associated first 40 or second 42 edges, or other edges, of the air bag 12 during the first gathering operation, so as to prevent the associated first 40 and second 42 edges, or other associated edges, from becoming captured within the folds of the gathered air bag 22.

Referring to FIG. 13, in accordance with a second embodiment of the second aspect of an apparatus for folding an airbag for stowing in an air bag module, the lower inside portion of the first 36 or second 38 faces of the first 28 or second 30 gathering elements, or other associated faces of other associated gathering elements, is provided with a pocket 114, for example, lined with a compliant material 116 such as rubber or foam, which provides for holding the associated first 40 or second 42 edges, or other edges, of the air bag 12 during the first gathering operation, so as to prevent the associated first 40 and second 42 edges, or other associated edges, from becoming captured within the folds of the gathered air bag 22.

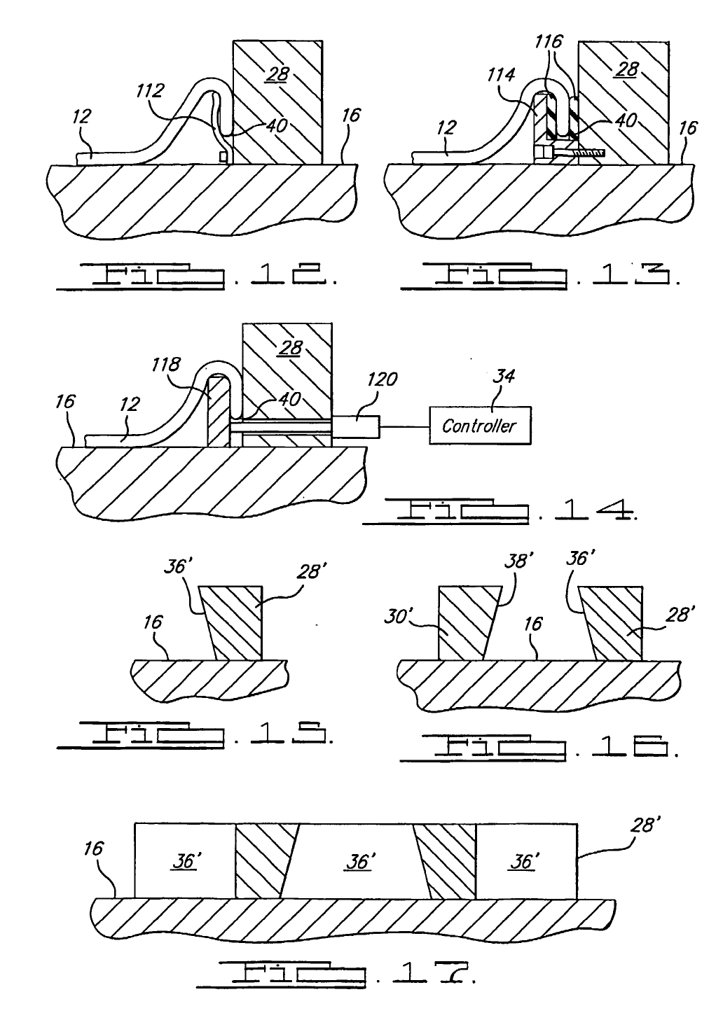

Referring to FIG. 14, in accordance with a third embodiment of the second aspect of an apparatus for folding an airbag for stowing in an air bag module, the lower inside portion of the first 36 or second 38 faces of the first 28 or second 30 gathering elements, or other associated faces of other associated gathering elements, is provided with a clamp 118 actuated by an associated actuator 120 responsive to a signal from the controller 34, which provides for holding the associated first 40 or second 42 edges, or other edges, of the air bag 12 during the first gathering operation, so as to prevent the associated first 40 and second 42 edges, or other associated edges, from becoming captured within the folds of the gathered air bag 22.

Referring to FIGS. 15-17, in accordance with a third aspect of an apparatus for folding an airbag for stowing in an air bag module, the first 28′ and second 30′ gathering elements and the third 66′ and fourth 68′ gathering elements are adapted with associated respective first 36′, second 38′, third 72′ and fourth 74′ faces that are sloped inwards and upwards relative to the first surface 16 and the center 52, so as to provide for urging the corresponding first 54, second 56, third 84 and fourth 86 edge portions of the air bag 12 towards the first surface 16 during the first gathering operation, so as to so as to prevent the associated first 40 and second 42 edges, or other associated edges, from becoming captured within the folds of the gathered air bag 22. It should be understood that the first 36′, second 38′, third 72′ and fourth 74′ faces could be alternatively be made curved.

By helping to prevent the associated first 40 and second 42 edges, or other edges similarly processed, from becoming captured within the folds of the gathered air bag 22, the air bag folding apparatus 10 and associated method can provide beneficial deployment characteristics of an air bag 12 folded in accordance therewith.

While specific embodiments have been described in detail, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the fill breadth of the appended claims and any and all equivalents thereof.

What is claimed is:

1. A method of folding an air bag for stowing in an air bag module, comprising:
a. spreading out an empty air bag on a surface between first and second gathering elements, wherein said first and second gathering elements are opposed to one another;
b. moving said first and second gathering elements towards a center and towards one another so as to gather said air bag together between said first and second gathering elements;
c. adapting said first gathering element so as to limit a first height of a first edge portion of the air bag proximate to said first gathering element relative to said surface to less than a first threshold during at least a portion of the operation of moving said first and second gathering elements; and
d. adapting said second gathering element so as to limit a second height of a second edge portion of said air bag proximate to said second gathering element relative to said surface to less than a second threshold during at least a portion of the operation of moving said first and second gathering elements, wherein said first and second thresholds are each less than a third height of said air bag proximate to said center after the operation of moving said first and second gathering elements.

2. A method of folding an air bag for stowing in an air bag module as recited in claim 1, wherein at least one of the operations of adapting said first gathering element and adapting said second gathering element comprises at least one of extending a first slider from said first gathering element towards said center and extending a second slider from said second gathering element towards said center, and a distance of said first slider from said surface is equal to said first threshold and a distance of said second slider from said surface is equal to said second threshold.

3. A method of folding an air bag for stowing in an air bag module as recited in claim 2, wherein at least one of the operations of extending said first slider and extending said second slider is by an positioner responsive to a controller.

4. A method of folding an air bag for stowing in an air bag module as recited in claim 2, wherein at least one of the operations of extending said first slider and extending said second slider is responsive to at least one of a first position of said first gathering element on said surface and a second position of said second gathering element on said surface.

5. A method of folding an air bag for stowing in an air bag module as recited in claim 1, wherein at least one of the operations of adapting said first gathering element and adapting said second gathering element comprises at least one of providing for holding a first edge of said air bag against said first gathering element proximate to said surface and providing for holding a second edge of said air bag against said second gathering element proximate to said surface, further comprising at least one of holding said first edge of said air bag against said first gathering element proximate to said surface and holding said second edge of said air bag against said second gathering element proximate to said surface.

6. A method of folding an air bag for stowing in an air bag module as recited in claim 1, wherein at least one of the operations of adapting said first gathering element and adapting said second gathering element comprises at least one of shaping a first face of said first gathering element so as to urge said first edge portion of said air bag towards said surface responsive to the operation of moving said first and second gathering elements, and shaping a second face of said second gathering element so as to urge said second edge portion of said air bag towards said surface responsive to the operation of moving said first and second gathering elements.

7. A method of folding an air bag for stowing in an air bag module as recited in claim 1, further comprising moving third and fourth gathering elements towards a center and towards one another so as to gather said air bag together between said third and fourth gathering elements, wherein said first and second gathering elements are operative in a first direction, said third and fourth gathering elements are operative in a second direction, and said first and second directions are different from one another.

8. A method of folding an air bag for stowing in an air bag module as recited in claim 7, wherein said first and second directions are substantially orthogonal with respect to one another.

9. A method of folding an air bag for stowing in an air bag module as recited in claim 7, further comprising:
a. adapting said third gathering element so as to limit a third height of a third edge portion of the air bag proximate to said third gathering element relative to said surface to less than a third threshold during at least a portion of the operation of moving said third and fourth gathering elements; and
b. adapting said fourth gathering element so as to limit a fourth height of a fourth edge portion of said air bag proximate to said fourth gathering element relative to said surface to less than a fourth threshold during at least a portion of the operation of moving said third and fourth gathering elements, wherein said third and fourth thresholds are each less than said third height of said air bag proximate to said center after the operation of moving said third and fourth gathering elements.

10. A method of folding an air bag for stowing in an air bag module as recited in claim 1, further comprising stowing said air bag in an air bag module after said air bag is gathered responsive to the operation of moving said first and second gathering elements.

11. An apparatus for folding an air bag for stowing in an air bag module, comprising:
a. a first surface adapted to support the air bag;
b. first and second gathering elements, wherein said first and second gathering elements are located over said first surface and are adapted to move with respect thereto, said first gathering element comprises a first face, said second gathering element comprises a second face, said first and second faces are opposed to one another, and said first and second faces are adapted to engage opposing edges of said air bag; and
c. at least one second surface adapted to cooperate with at least one of said first and second gathering elements, wherein said at least one second surface is adapted to extend from at least one of said first and second faces so as to limit a height of at least one corresponding edge portion of said air bag proximate to said at least one of said first and second faces when said air bag is gathered between said first and second gathering elements by moving said first and second gathering elements towards one another over said first surface.

12. An apparatus for folding an air bag for stowing in an air bag module as recited in claim 11, wherein said at least one second surface is on at least one slider adapted to cooperate with said at least one of said first and second gathering elements, and said at least one slider is adapted to engage with a corresponding at least one slot in said at least one of said first and second gathering elements.

13. An apparatus for folding an air bag for stowing in an air bag module as recited in claim 12, wherein said at least one slider comprises a stop adapted to limit a travel of said at least one slider within said at least one slot.

14. An apparatus for folding an air bag for stowing in an air bag module as recited in claim 12, further comprising at least one positioner adapted to control a position of a corresponding at least one slider, wherein said position of said at least one slider with respect to said at least one of said first and second gathering elements is controlled by said positioner responsive a position of said at least one of said first and second gathering elements with respect to said first surface.

15. An apparatus for folding an air bag for stowing in an air bag module as recited in claim 11, wherein said at least one second surface is either coincident with or operatively coupled to said first or second face, and said at least said at least one second surface is sloped towards the opposing gathering element upwards from said first surface.

16. An apparatus for folding an air bag for stowing in an air bag module as recited in claim 11, further comprising third and fourth gathering elements, wherein said third and fourth gathering elements are located over said first surface and are adapted to move with respect thereto, said third gathering element comprises a third face, said fourth gathering element comprises a fourth face, said third and fourth faces are opposed to one another, said third and fourth faces are adapted to engage opposing edges of said air bag, said first and second gathering elements are operative in a first direction, said third and fourth gathering elements are operative in a second direction, and said first and second directions are different from one another.

17. An apparatus for folding an air bag for stowing in an air bag module as recited in claim 16, wherein said first and second directions are substantially orthogonal with respect to one another.

18. An apparatus for folding an air bag for stowing in an air bag module as recited in claim 17, further comprising at least one third surface adapted to cooperate with at least one of said third and fourth gathering elements, wherein said at least one third surface is adapted to extend from at least one of said third and fourth faces so as to limit a height of at least one corresponding edge portion of said air bag proximate to said at least one of said third and fourth faces when said air bag is gathered between said third and fourth gathering elements by moving said third and fourth gathering elements towards one another over said first surface.

19. An apparatus for folding an air bag for stowing in an air bag module, comprising:
a. a first surface adapted to support the air bag;
b. first and second gathering elements, wherein said first and second gathering elements are located over said first surface and are adapted to move with respect thereto, said first gathering element comprises a first face, said second gathering element comprises a second face, said first and second faces are opposed to one another, and said first and second faces are adapted to engage opposing edges of said air bag; and
c. at least one holder adapted to cooperate with at least one of said first and second gathering elements, wherein said at least one holder is adapted to extend from at least one of said first and second faces so as to hold at least one corresponding edge portion of said air bag proximate to said at least one of said first and second faces when said air bag is gathered between said first and second gathering elements by moving said first and second gathering elements towards one another over said first surface.

20. An apparatus for folding an air bag for stowing in an air bag module as recited in claim 19, wherein said at least one holder comprises a clamp or a pocket.
